(19) United States
(12) Patent Application Publication
(10) Pub. No.: US 2006/0015825 A1
(43) Pub. Date: Jan. 19, 2006

(54) 2-D symbol reading system with guide window for confirmation

(76) Inventors: Shinichi Mizuno, Saitama (JP); Yuichi Motoi, Matsuyama (JP)

Correspondence Address: KAPLAN GILMAN GIBSON & DERNIER L.L.P., 900 ROUTE 9 NORTH, WOODBRIDGE, NJ, 07095, US

(21) Appl. No.: 10/889,982

(22) Filed: Jul. 13, 2004

(51) Int. Cl. G06F 17/00; G06F 9/00

(52) U.S. Cl. 715/864

(57) ABSTRACT

Apparatus for facilitating the accurate positioning of a personal device such as a mobile phone with a display thereon is disclosed. The apparatus includes a viewing window with a field of view coinciding with the field of view of a camera, and an illumination means positioned above a display inserted for reading. The user can view the display to insure that it is properly positioned.

### TECHNICAL FIELD

This invention relates to a symbol reading system, and more particularly, to a system for reading displays such as, for example, two dimensional bar codes that may be displayed on a display of a personal communications device, such as a mobile telephone.

### BACKGROUND OF THE INVENTION

Personal communications devices, such as mobile phones, personal digital assistance (PDA) and others, have advanced to the point of containing relatively good quality displays. These displays are sometimes used to display symbols, for example, barcodes, which may be read and utilized as an indicator of credit for of the purchase of goods and services.

For example, a user desiring to purchase two movie tickets may call or contact via the Internet the ticket seller in advance. A particular encoded display, such as a one or two dimensional barcode or other type of symbol, may be downloaded to the mobile phone and will be displayable on the display. When arriving at the movie theater, a user needs only to insert his mobile phone with display into a reader, which will read the barcode and admit two patrons to a movie as a result thereof.

In prior systems for reading such displays, a problem is that the user may not always position the personal communications device or mobile phone correctly within the reader. Often they must jiggle or move around the mobile phone in order to appropriately align the display with the camera's viewing field so that the camera can read the one or two dimensional barcode. A complicating factor is that various models of mobile phones, personal communication devices, and personal digital assistants, any of which may include the display for displaying the one or two dimensional barcode, are shaped and sized differently. Therefore, a convenient mechanical guide to force the display to the proper camera-viewing area is difficult to manufacture.

Another complicating factor is that displays are typically read face down, so that the user moves the display over the camera-viewing area, which is facing upwardly. As a result, the user moving the display over the viewing area cannot even clearly see the one or two dimensional barcode or other symbol that the scanner is attempting to read, since the display is downward facing.

In view of the foregoing, there exists a need in the art for an improved device for scanning and reading one or two dimensional symbols from displays such as those implemented on a mobile telephone or other personal communications device or personal digital assistant.

### SUMMARY OF THE INVENTION

The above and other problems of the prior art are overcome in accordance with the invention which relates to an apparatus for ensuring accurate positioning of mobile telephones and other personal devices when being inserted for scanning and reading. In accordance with the invention, the illuminating LED is placed above a portion at which the display is inserted, and the reader or camera for capturing the image is positioned also above the image to be read. A viewing window permits the user's eye to view an area of the display that is substantially aligned with the area viewed by the camera, so that the user can assure that the display is positioned correctly within the field of view of the camera or other reader. Accordingly, the user may quickly insert the device having the display, and confirm that it is properly positioned, regardless of the shape or size of the viewing area.

### BRIEF DESCRIPTION OF THE DRAWINGS

FIG. 1 depicts a cross section of an exemplary embodiment of the present invention; and

FIG. 2 shows a specific type of cover for use with the present invention.

### DETAILED DESCRIPTION OF THE PREFERRED EMBODIMENT

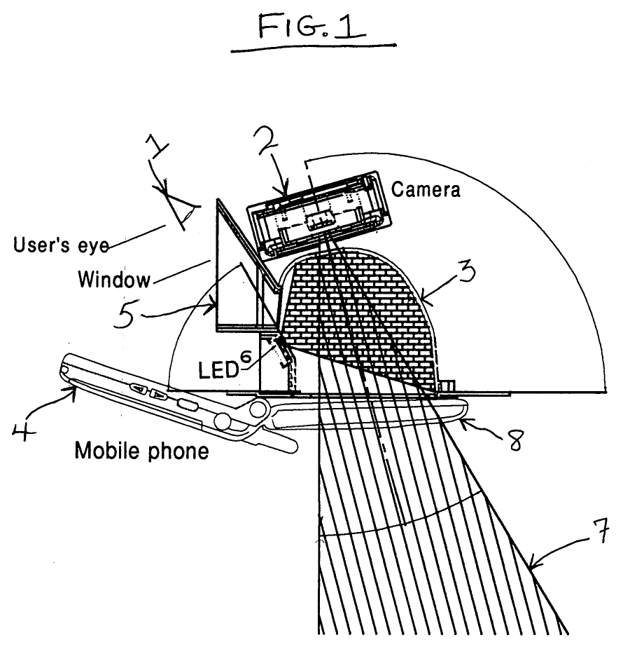

FIG. 1 depicts an exemplary embodiment of the present invention including a camera 2 for reading the one or two dimensional symbols on the display, a viewing window 5, an LED 6, cover 3, and an exemplary mobile phone 4. A field of view camera 2 is indicated in hash lines as 7, which depicts an area on display that will be covered by such field of view. While a mobile phone is shown for exemplary purposes, the invention is not so limited.

In accordance with the invention, the user's eye is shown as 1 and is directed through a window 5 to force it to cover a field of view that covers substantially a similar area as the field of view of camera 2 on display 8. Hence, when a user slides in his mobile phone 4, he can view the display area 8 through a window 5 and insure that the symbol to be read is within the field of view of camera 2, and centered appropriately, as he can see the display and symbols through the viewing window 5. The substantial coincidence of the viewing area of camera 2, which serves as a reader, and the window 5 permits the-accurate alignment of the display 8 with the camera

Once positioned correctly, LED 6 illuminates the symbols to be read from the display 8, and the camera 2 then captures and transmits for processing the appropriate image.

A covering 3 surrounds the area into which the mobile phone 4 is inserted, and serves to diffuse the illumination generated by LED 6 onto the LCD display 8. This provides a more accurate reading of the display, as explained below.

The upper surface of the LCD display surface behaves somewhat like a mirror and the direct lighting of the LCD by the LED 6 does not properly illuminate the contents in the display. In the case of direct illumination, the light source such as LED itself and any objects surrounding the LCD are reflected back to camera by the upper surface of the LCD display. Therefore, the information on the LCD such as the barcode is interfered with by the said light source or objects. This is the reason why it is difficult to read the information by the direct light.

In order to avoid this difficulty, evenly distributed and diffused light needs to illuminate the LCD and its surroundings. The light generated by the light source such as the LED is first directed toward the cover 3 of the device, which generates even and diffused light. This illuminates the LCD evenly. The light source such as LED 6 and any objects surrounding the LCD thus do not interfere with the information from the barcode. The indirect light generated by the LED 6 in conjunction with the covering 3 is then reflected back to the camera 2, carrying the information displayed on the LCD display 8. The dome-shaped cover 3 serves to generate indirect lighting and diffuse the generated indirect lighting onto the LCD display with relatively even illumination of the contents, such as the barcode, in the display area on the surface below.

Put another way, while the LCD display itself might not be easily readable when illuminated by a direct light source, by using the indirect light source comprised of the dome shaped cover 3 and an LED 6, the display can be read with a reasonably high degree of accuracy.

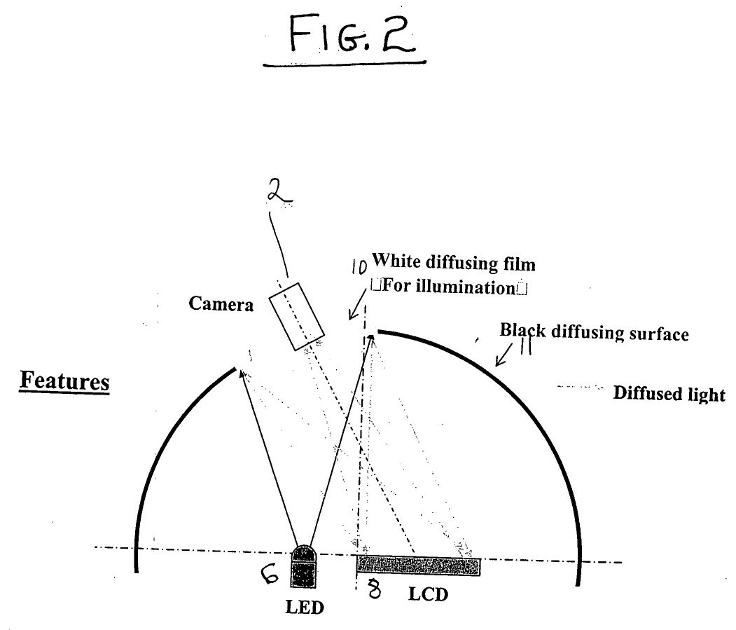

In an additional enhancement, the cover 3 is comprised of separate portions that are absorptive and diffusive with respect to incident light. As shown in FIG. 2, a white diffusing film, or any surface made to diffuse light, 10 may be utilized over the appropriate portion of cover 3, while a black light absorptive surface covers substantially all the remaining inner surface. Such a structure for the cover 3 causes the LCD to be evenly illuminated by diffused light, and also causes the reflected light captured by the camera 2 to consist almost entirely of the light reflected by the LCD display, thus carrying the information desired to be read.

While the foregoing describes the preferred embodiments of the invention, it is understood that various modifications will be apparent to those of skill in the art. For example, the device need not necessarily be a mobile phone, and the camera 2 may be positioned in other areas with respect to the covering 3. Additionally, the symbols read from the display may be any type of symbols, such as characters, barcodes, or other types of codes that may be scanned and read with an illumination source and detector. The illumination source need not be the LED as shown, but maybe other such sources. The foregoing and other embodiments are intended to be covered by the claims appended hereto.

1. A method of reading a display comprising providing a viewing window, said viewing window having a first field of view, providing a reading means, said reading means having a second field of view, said first and second fields of view being oriented such that said first field of view is substantially within said second field of view, inserting a personal communications device having a display into said first field of view so that it is within said second filed of view, and reading said display electronically thereafter.

2. The method of claim 1 wherein said personal communications device is a cellular telephone.

3. The method of claim 2 further comprising providing a cover substantially surrounding said first and second field of views, but having openings permitting a human and a reading means to view said display, said cover being shaped and sized to cause a substantially uniform light source to illuminate said display.

4. The method of claim 3 wherein said display displays either one or two dimensional bar code data.

5. The method of claim 3 wherein further comprising illuminating the display with a light source.

6. The method of claim 4 further comprising illuminating said display with a light source.

7. The method of claim 5 or 6 wherein said light source is a light emitting diode.

8. The method of claim 7 wherein said display in a liquid crystal display (LCD.

9. Apparatus for reading a display comprising a light source for illuminating said display, a reader for reading symbols from said display, and a viewing window, said viewing window and said reader being above an opening into which a personal communications device having a display is to be inserted, said viewing window and said display each having a field of view, said fields of view being substantially aligned so as to cause the display, when said personal communications device is inserted, to be aligned for substantially optimum reading by said reader when said display is substantially within the field of view of said viewing window.

10. Apparatus of claim 9 wherein said light source is a light emitting diode (LED).

11. Apparatus of claim 10 wherein said display is a liquid crystal display (LCD).

12. Apparatus of claim 11 wherein said LED light source is positioned just below said viewing window.

13. Apparatus of claim 12 wherein said viewing window is formed in a cover which otherwise substantially covers said apparatus, and wherein said cover and said LED form a light source for providing substantially uniform light for reading the LCD display.

14. Apparatus for reading a display comprising a light source, an opening for the insertion of a device carrying said display, and a cover, the cover having an inner surface, a first portion of said inner surface being diffusive of incident light, and a second portion of said inner surface being absorptive of said incident light, and a reader, said light source, said cover, said reader, and said first and second portions being arranged such that light from said light source is diffused and substantially evenly illuminates the display, and information on said display is then captured by said reader, and additional potentially interfering light is absorbed by said absorptive portion.

15. Apparatus of claim 14 wherein said light source is an LED.

16. Apparatus of claim 14 wherein said display is a one or two dimensional bar code.

17. Apparatus of claim 14 wherein said display is an LCD.

18. Apparatus of claim 17 wherein said light source is an LED.
